(19) United States
(12) Patent Application Publication
(10) Pub. No.: US 2010/0076776 A1
(43) Pub. Date: Mar. 25, 2010

(54) Fundraising and Recruitment Methods

(76) Inventors: Michael Kopko, New York, NY (US); Matthew Edward Kopko, Chicago, IL (US)

Correspondence Address: Hiscock & Barclay, LLP, One Park Place, 300 South State Street, Syracuse, NY, 13202-2078, US

(21) Appl. No.: 12/235,373

(22) Filed: Sep. 22, 2008

(51) Int. Cl. G06Q 30/00; G06Q 90/00

(52) U.S. Cl. 705/1; 705/14.2

(57) ABSTRACT

A computer-based system collects performance information, e.g., grades, submitted by students. The system automatically searches its database to see if the performance information satisfies any sponsorship pledges contained in the database. If so, the system executes the pledge and rewards the student for the good performance. The system can also be used to sponsor education programs, and to find suitable job candidates with the right performance records and credentials.

### BACKGROUND OF THE INVENTION

The present invention relates generally to ways for monetizing personal performance information and for recruiting talents, more specifically, in preferred embodiments, to raising funds for education and to recruiting students out of school.

Education remains a priority concern for all families, and is getting more and more expensive. Currently, there are very few ways to raise funds for students or prospective students, and they are typically limited to immediate family members and largely operate on a gratuitous basis, i.e., as gifting services. Some have linked such services to spending habits, for example, Upromise, Inc. allows parents to register their credit cards under their children's college fund so that a percentage of what they spent on participating retailers (mostly grocers, gas stations and restaurants) through those particular credit cards go to the college fund.

There remains a widely felt need for creative, far-reaching ways to raise money for educational funds.

### BRIEF SUMMARY OF THE INVENTION

In general, the present invention provides a computer-based system that provides a mechanism for a person to get rewarded for his performance and/or other personal information. The system also allows an interested party to offer rewards or to recruit talents based on certain criteria. More specifically with regard to its application in the education field, the present invention provides a way for students to get rewarded for good grades, thereby enlarging the donor circle beyond parents—relatives, friends, acquaintances, neighbors, community organizations, non-profit groups, businesses, government agencies, and anyone who has an interest in students getting better grades, maintaining good standing at school, and, in general, perform well academically or athletically and so on, can now provide financial incentives for such performance. The present invention not only enables a family to tap into their social network in order to raise money for their children's future, but also provides a channel for businesses and the public sector to pitch in. In particular, by providing prizes, businesses can encourage students to study subject matters that are important for their respective industries, and to access students who have achieved in certain fields and subject matters. This allows corporations to encourage certain types of studies without having to set up their own education programs, which are often costly. The invention also saves tremendous amount of corporate spending on recruitment while providing validated and focused searches for job candidates. It also allows businesses that otherwise do not have the resources to stage on-campus recruiting the opportunity to reach student talents.

In a basic embodiment, the system collects information on a student's performance (e.g., grades) and informs an existing or potential sponsor of the performance, and executes a pre-programmed action the sponsor or the system has agreed to if the performance meets a preset criterion. Typically, the performance information is validated by the system. The system also permits searches by an existing or potential sponsor or recruiter. While capable of protecting the privacy of parties involved, the system provides a tool for efficient, effective and inexpensive recruitment.

In one aspect, the invention provides a computer-based system that includes:
an input module that receives a student's performance information comprising a value;
a memory in communication with said input module for storing at least said value;
a processing module in communication with said memory for determining if said value meets a criterion set in a sponsorship pledge by a sponsor; and
an output module in communication with said processing module for executing the sponsorship pledge by initiating a process for rewarding said student if said processing module determines that said value meets said criterion.

In one feature, the processing module validates said performance information before signaling said output module that said value meets said criterion. In one embodiment, the validation is conducted through the system communicating said performance information to an institution, e.g., the one that assigns said value, for confirmation of its accuracy or authenticity. In another embodiment, the performance information is transmitted from an institution that assigns said value, e.g., from the school where the student is attending class in the form of an official grade report or transcript. Information uploaded directly from the institution is considered validated. The performance information may include identity of the student and information on an event leading to the underlying performance.

In one feature, rewarding said student comprises carrying out a transaction involving money or its equivalent, which may be selected from the group consisting of cash, credit, a fund, a gift, a grant, a scholarship, a loan, a good, a service, a discount, publicity, an experience, an offer for employment, and an interview for employment. The employment can be paid or unpaid positions.

In one feature, the input module further receives said sponsorship pledge in which said sponsor designates said criterion for student reward. In other words, it is a decentralized process where a sponsor can, independently from any student, set up a pledge by accessing the system over a network connection such as the Internet. The sponsor can specify a cause to support by sponsoring a pledge. In various embodiments, the cause includes one or more elements selected from the following: subject matter, topic, field, major, concentration, goal, industry, instructor, academic department, instructing institution, and course. And the sponsor may be a person, a business, a government agency, a non-governmental organization, an educational institution, a foundation, or a trust.

In an embodiment, the sponsorship pledge rewards one or more students for getting a grade higher than a threshold value or a target value.

In a feature, the output module of the system further transmits a printable report of at least the value in said performance information to said sponsor. Once the pledge is carried out, the output module further transmits a printable report of the execution of said sponsorship pledge to said sponsor and/or student and agent. In an embodiment, the output module further contacts said student on behalf of said sponsor.

In a feature, the memory of the system stores part (e.g., the “value”) or all of the performance information in a searchable database. In another feature, the input module further receives personal information from said student and said memory further stores said personal information. In an embodiment, the output module pays said student each time personal information is received at said input module.

In another aspect, the present invention provides a method of rewarding a student for a performance, said method comprising the steps of:
providing a computer system to receive a student's performance information comprising a value;
storing at least said value in a database in said computer system;
determining if said value meets a criterion set in a sponsorship pledge by a sponsor; and
executing said sponsorship pledge by initiating a process for rewarding said student of said performance if said value is determined to meet said criterion.

According to various features of the method, the computer system may allow said sponsor to designate which student or students to sponsor; the computer system may also allow said sponsor to designate which cause to sponsor. In one feature, the computer system is accessible through the Internet.

In one feature of the method, the system allows a third party to search said memory, and/or to offer a reward to one or more students identified through the search. The reward may include an offer for employment or an interview for employment. In one embodiment, the system contacts said student on behalf of said third party thereby keeping said student's identity hidden from said third party at least temporarily.

In one feature, the inventive method further includes steps of asking for personal information from said student, storing said personal information upon receipt, and paying said student each time personal information is received.

According to yet another aspect, the invention provides a computer-based system comprising:
an input module that receives multiple pieces of performance information from a plurality of students, each piece of information comprising a value;
a memory in communication with said input module for storing at least each of said values from said multiple pieces of performance information;
a search module in communication with said memory for searching values based on one or more criteria; and
an output module in communication with said search module for providing a printable search result of one or more students associated with one or more values that meet said one or more criteria.

In an embodiment, said printable search result excludes any information directly identifying said plurality of students. In various embodiments, said one or more criteria comprises at least one entity selected from the group consisting of subject matter, topic, field, major, goal, industry, instructor, instructing institution, course, grade, academic score, athletic achievement, certification, credit score, admission or acceptance to an academic institution, and membership.

In one feature, said memory further stores personal information of said plurality of students. In another feature, the system further attempts to validate each of its stored value. In an embodiment, each performance information is indicated as to its validation status.

### BRIEF DESCRIPTION OF THE DRAWINGS

FIG. 1A is a block diagram outlining how students might interact with the system of the invention in an embodiment.

FIG. 1B is a screenshot illustrating one example of an invitation template that a student user can use to invite someone to become a sponsor.

FIG. 2 is a block diagram outlining how sponsors might interact with the system of the invention in an embodiment.

FIG. 3 is a block diagram outlining how, in an embodiment, the system might function as new performance information or pledge is uploaded onto the system of the invention.

FIG. 4 is a block diagram illustrating an embodiment of the system.

### DETAILED DESCRIPTION OF THE INVENTION

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the course of providing what is believed to be the most useful and readily understood description of the principles and conceptual aspects of the invention. The description taken with the drawings making apparent to those skilled in the art how the several forms of the invention may be embodied in practice. In figures, like elements are referenced with like numerals throughout.

The principles of the invention are most often illustrated through examples of a student's education, but should not be construed to be limited to such. In general, the present invention provides a computer-based system that uploads performance information and personal information in a memory. The system preferably validates the information. The system also processes the information to determine if the condition for a sponsorship pledge is satisfied, and if so, the pledge is executed and the sponsor is notified. Additional searching capability provides other applications for the system, e.g., in recruitment.

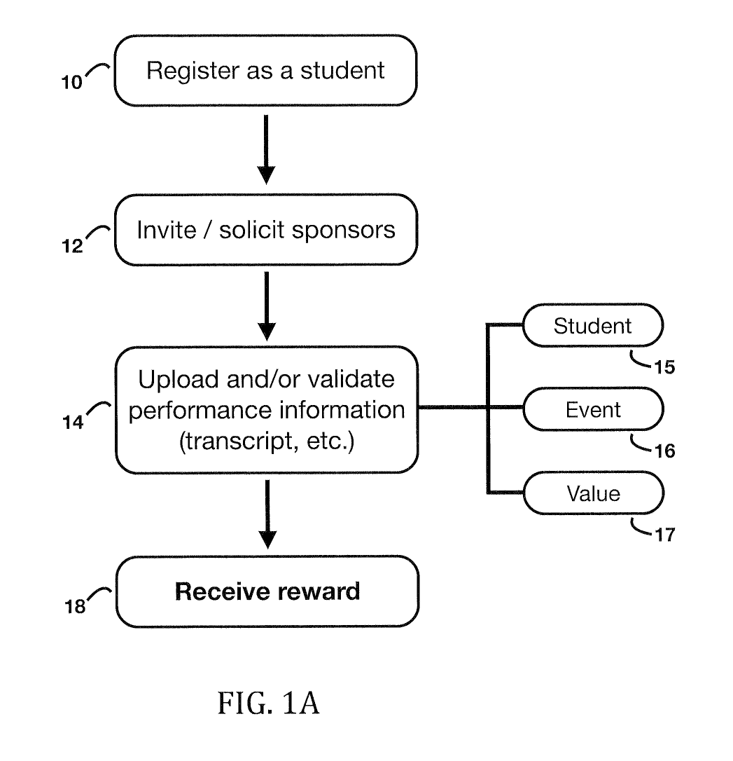

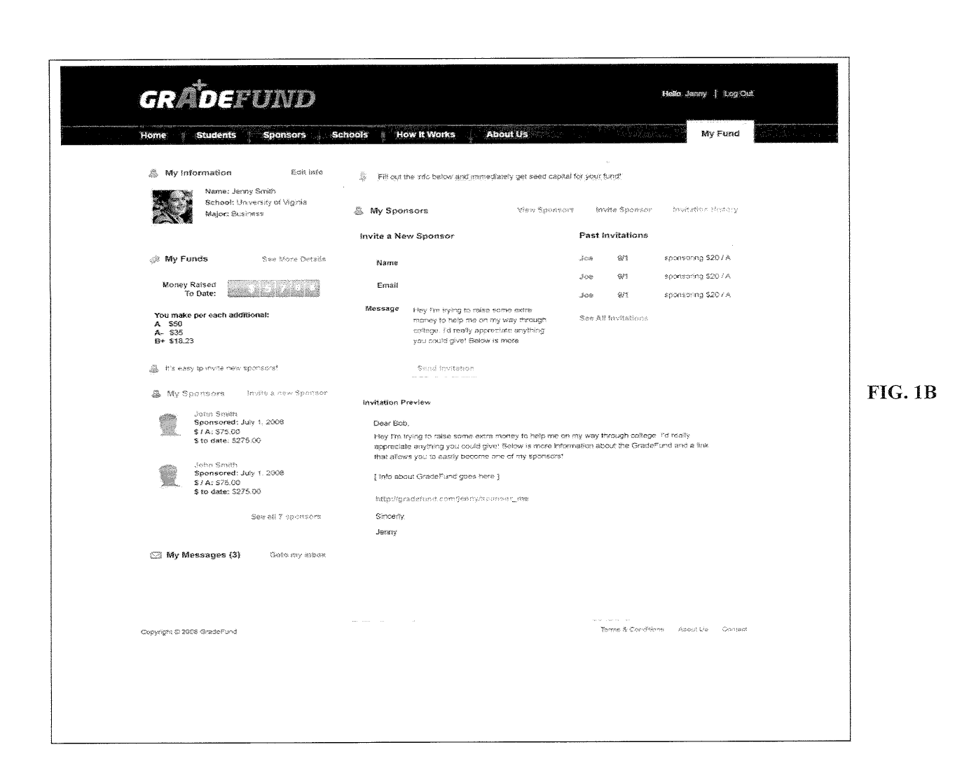

FIG. 1A illustrates how a performer, e.g., a student, interacts with a system embodiment of the invention (e.g., called “GradeFund”) in a block diagram. The system is computer-based and can be accessed through a network such as the Internet. For example, the student can access GradeFund by visiting a website. The student can be of any age, studying any field or discipline, affiliated with any educational institution or is simply a prospective student. He can be a graduate student, a college student, a high school student, a military cadet, a trainee, an apprentice, a full-time student, a part-time student, and so on. In step 10, the student, or a representative/agent/guardian/parent (hereinafter, the “student user”) registers with the system as a student/user, preferably on-line. This may entail providing basic contact information that may include name, mailing address, email address, telephone number, date of birth, affiliation (school, for instance), a password, and so on. The student user also needs to designate a preferred way of receiving rewards—a check mailed to an address (e.g., to the student or to the school) or direct deposit to a bank account, etc. In one embodiment, the student user's GradeFund account functions also as a bank account from which checks can be directly issued.

In step 12, the student or his agent then sets out to invite or solicit sponsors. In one embodiment, the system of the invention provides an invitation template for the student user to send to potential candidates. An example is provided in FIG. 1B, which provides space for a personalized message and allows the student user to track which potential sponsor has been contacted and when. Alternatively, the student user can craft his own invitation template. The invitations can be sent through the system, e.g., electronically, and tracked by the system, which may send friendly reminders to potential sponsors at a later time. Of course, the student user can invite a sponsor through other means such as a telephone call, a meeting, a conversation, advertisement, or written correspondence.

In step 14, the student user uploads or otherwise inputs performance information into the system of the invention, optionally, the student user also authenticates or validates the information. In one embodiment, the student user mails a paper record indicating the performance information, e.g., a copy of a transcript. Alternatively, the student users transmits, e.g., faxes or emails, an electronic copy of the record. The student user can also have another entity, preferably the entity that issues the information, upload that information. For example, the student user can designate GradeFund to receive an official copy of the transcript from the attending school or an official SAT report from the test's administer, Educational Testing Service. This automatically authenticates or validates the information. The performance information may be of various kinds and in various forms depending on the student's situation. For example, the performance information may include a grade, an academic score, an athletic achievement, a certification, an honor, an award, a credit score, admission or acceptance to an academic institution, and a membership. The performance information is preferably merit-based, for example, a certification of a skill set, (e.g., of certain computer skills) the honor of making the dean's list, a membership to a scholastic honor society (e.g., Phi Beta Kappa), and so on. Some specific examples of academic performance information includes AP (Advanced Placement) scores, SAT, ACT, GMAT, LSAT, MCAT scores.

In one feature, the performance information includes at least three components 15-17, representing “student” (15), “event” (16) and “value” (17), respectively. In a processor-ready embodiment, these three components appear as three fillable fields in a computerized questionnaire, e.g., a web page. Component 15 by default is the identity of the student himself or the student represented by the agent/user of the system, therefore, may not need to be filled in again and may not appear as a fillable field at all. Component 16 asks the student user to describe the “event” leading to the underlying performance. For example, the “event” can be one or more tests, one or more classes, a competition, an award, an acceptance (e.g., to a college) or admission (e.g., to a honor society), etc. In an embodiment of the inventive system, the web page provides a drop-down menu with some of the most common academic events for the student user to choose from. Alternatively, the student user can describe the “event” in his own words. In another embodiment, the drop-down menu includes all the corresponding “events” specified by the student's sponsors as can potentially earn the student an reward. Component 17 asks the student a “value” that represents his performance in the “event,” preferably in a form that can be understood and processed by a computer processor. That value can be a symbol, a character, a letter, a word, a phrase, a number, an alphanumerical value, or a combination of any of the above (e.g., “B+”). The value can represent a score, a grade, a grade point average, and so on. The “value” can be a binary entry indicating whether a statement is true or false, for example, if the “event” is “admission to an academic honor society,” then the “value” can be either “true/yes” or “false/no”.

In step 18, if the student's performance satisfies at least one sponsor's pledge condition, he receives the reward specified in the pledge. In various embodiments, the reward includes money or its equivalent. It is noted that the steps illustrated in this and other figures do not necessarily have to take place in the order shown. For example, step 14 can take place before or concurrently with step 12.

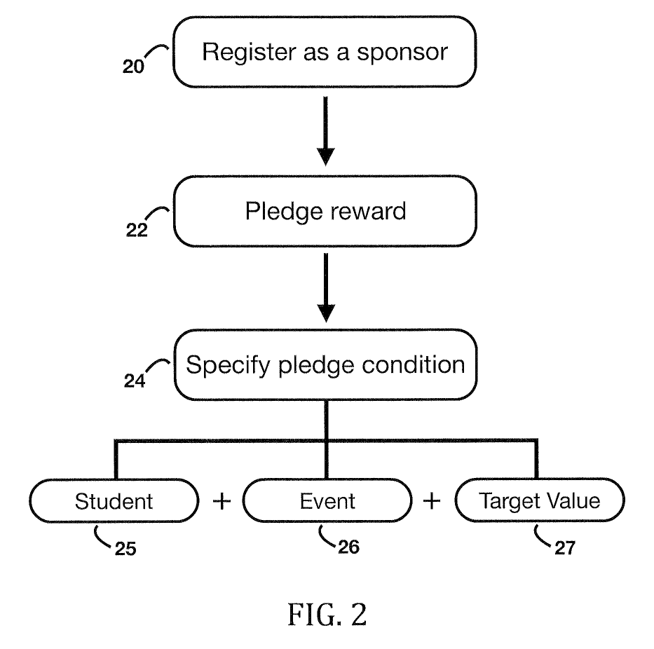

FIG. 2 illustrates how a sponsor interacts with the GradeFund, a system embodiment of the invention. The sponsor can be an individual person or a group of persons, e.g., relatives, friends, associates, companions, and personal acquaintances of the student user. The sponsor can be one or more organizations, e.g., businesses, government agencies, non-governmental organizations, educational institutions, foundations, and trusts. Basically, any entity interested in sponsoring one or more students can sign up with or without an invitation. In step 20 shown in FIG. 2, the interested entity register as a sponsor, e.g., on-line. This may entail providing the system with basic contact information that may include (business) name, (business) address, contact person, etc. The sponsor needs to designate a preferred way of providing the reward pledged should the pledge condition be met. For example, the sponsor can deposit/prepay the pledged reward to the GradeFund, authorize charges to a bank account, a credit account, and so on, or ask to be billed or contacted later when pledge condition is actually met by the student's performance.

In step 22, the sponsor pledges the reward. In one embodiment, the sponsor sets a sponsorship level by selecting one of the cash amounts prompted by the system, e.g., $5, $10, $20, $100, and so on. The sponsor can also select a variable amount that depends on how good the student performance turns out to be. For example, the sponsor may pledge $10 for a “B” but $50 for an “A.” The reward can be money or its equivalent, such as cash, a grant, a scholarship, a loan, a good, a service, a discount for a good or service, publicity, an experience, an offer for employment, and an interview for employment. Examples of an experience being rewarded include: dinner with a celebrity, tickets to artistic venues, vacation trips/packages, and so on.

In step 24, the sponsor specifies pledge condition, i.e., the condition that will trigger the reward. In one embodiment, the pledge condition consists of at least three components 25-27, typically appearing as three fillable fields in a computerized questionnaire, with regard to “student” (25), “event” (26) and “target value” (27) respectively. Component 25 asks which student(s) the sponsor is interested in sponsoring—this can be a person or multiple people identified by their names, or a person or multiple people identified by a definition, e.g., “any female sophomore student enrolled in Harvard University, Cambridge, Mass.” The system, in an embodiment, allows the sponsor to search the names of all registered students or registered schools to specify whom to sponsor. In an embodiment where the sponsor is registering in response to an electronic invitation sent by the system, the name of the student on whose behalf the system sent out the original invitation appears as a default prompt when the sponsor attempts to fill this field. The sponsor can leave this field blank or select “any student” to make the pledge applicable to any registered student, e.g., until a pledged amount is exhausted.

Component 26 asks what “event” the sponsor is interested in sponsoring. Through component 25 and/or component 26, the sponsor is able to sponsor a cause that is of interest or importance to the sponsor. For example, for component 26, the sponsor may select from a wide variety of “events” that will satisfy this component of the pledge condition: enrolling at a particular instructing institution (e.g., Harvard University), in a particular academic department (e.g., the Arabic Language Department), under a particular instructor, in a particular major or concentration (e.g., geology); or taking instruction in a particular field (e.g., structural engineering), under a particular topic or subject matter (e.g., developing hydrogen fuel cell, designing vaccines against HIV), related to a particular industry (e.g., automobile design), or in a particular course (e.g., Physics 5003: Quantum physics in the twenty-first century). The sponsor may specify a particular cause because it encourages students to study a topic important for the sponsor's business, industry or other interest. And the sponsor can identify and build a long-term relationship with students who may turn out to be good job candidates. If the sponsor leaves this field blank or selects “any course,” the pledge will be applicable to any course taken by the student(s) being sponsored.

Component 27 asks the sponsor what “target value” ought to be set as a criterion that triggers the reward. In one embodiment, the “target value” is “better than” or “at least” a grade, a score or a grade point average. Other “target value” can also be a binary entry indicating whether a statement is true or false, for example, if the “event” is “admission to an academic honor society,” then the “value” can be either “true/yes” or “false/no”. The “target value” 27 shares the same features with the “value” 17 described with regard to FIG. 1A; those same features are not repeated for brevity. In one embodiment, the sponsor can go back to any of the above steps to revise either or both the pledged reward or the pledge condition. Again, the steps illustrated here do not necessarily have to take place in the order shown. For example, step 24 can take place before or concurrently with step 22.

As an example, a business interested in supporting the study of engineering in Ivy League colleges might pledge $5000 to sponsor $5 for each “A” earned in a qualifying undergraduate-level engineering class. To register that pledge in the system, the business designates a $5/person reward capped at $5000 in aggregate. Further, the pledge designates “Ivy League undergraduates” in the “student” field, “any undergraduate engineering course” in the “event” field (the GradeFund will generate the list of qualifying courses) and “at least A in grade” as the target value.

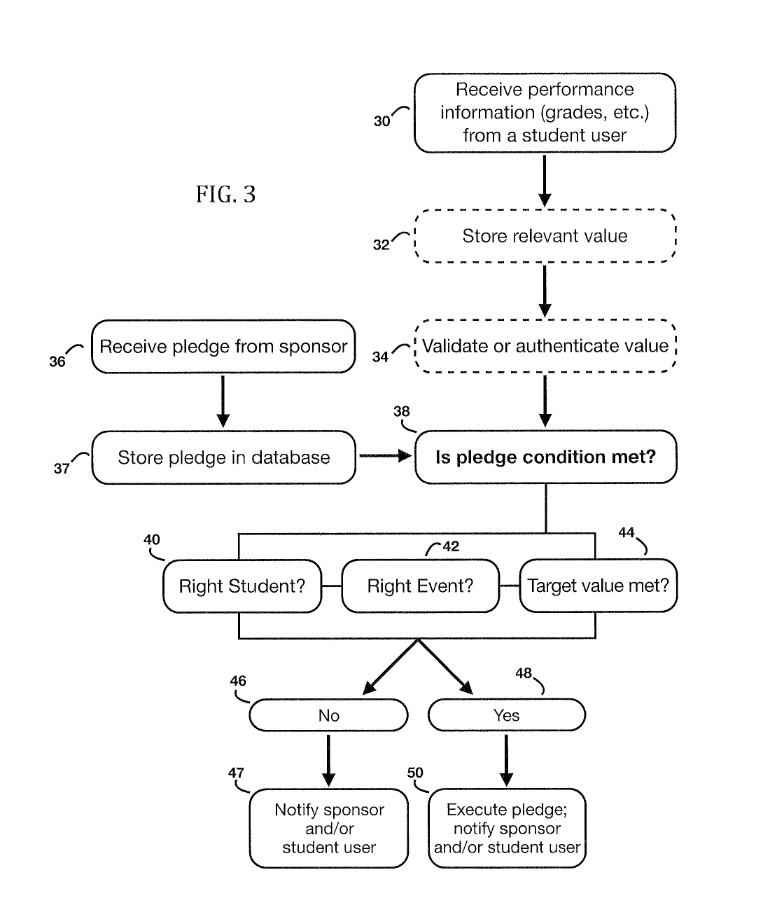

FIG. 3 illustrates how a system embodiment of the invention might function while interacting with both the student user and the sponsor. In one embodiment, in step 30, the system receives new performance information X₁ from a student user who uploaded the information or have it uploaded onto the system, as described previously with regard to FIG. 1A. The information X₁ can be viewed as including at least three components S₁ for “student” (15), E₁ for “event” (16) and V₁ for “value” (17) (see FIG. 1A). The system, in an optional step 32, stores in a memory, preferably in a searchable database, at least the “value” element V₁ (FIG. 1A) in the performance information. In a preferred embodiment, though optionally, the system attempts to validate or authenticate at least the “value” element or the entire performance information. In an embodiment, where the performance information, e.g., a transcript, is uploaded onto the system as an image file (e.g., as a scanned document, or facsimile), the system has an operator visually inspect the document for alteration from the original and/or electronically inspect the document for such alteration. In an alternative embodiment, the performance information received at the system is sent to the value-assigning institution, or an institution that can confirm the value, to have the information validated and confirmed. In a further alternative embodiment, a paper copy or an image file is received directly from the value-assigning institution and is upload, e.g., by scanning technologies, to the database.

Still referring to FIG. 3, on the other hand, the system has received pledges from sponsors (step 36) as described previously with regard to FIG. 2. Each pledge can be viewed as including the components S₀ for “student” (25), E₀ for “event” (26) and V₀ for “value” (27) (see FIG. 2) while some of the pledges may not impose any limitation on one or more of these components. These pledges are stored in a pledge database in step 37. In step 38, the system attempts to answer the question “Is any pledge condition met by the newly received performance information?” by examining each pledge it has received so far or otherwise available in the pledge database. In some cases, existing sponsor pledges are stored under or linked to a student account, so only those sponsor pledges are examined by the system. In one embodiment, a processor of the system attempts to answer this question by asking the following three questions though not necessarily in the following order. The first question can be “Is this the right student designated in this pledge?”, in other words, “Does S₁=S₀?” (step 40). If the answer is “yes,” the processor proceeds to ask a second question, which can be “Is this the right event designated in this pledge?”, in other words, “Does E₁=E₀?” (step 42). If the answer is “yes,” the processor proceeds to ask a third question, which can be “Does this value meet the target value designated in this pledge?”, in other words, “Does V₁ satisfy V₀?” (step 44).

If an answer to any one of the three questions is negative, then the answer to “Is the pledge condition met?” in step 38 is negative, and optionally in step 47, the sponsor and/or student is notified of the negative result, e.g., when at least the student is the right one specified in the pledge at issue (i.e., “yes” to step 40 question). If answers to all three questions are affirmative, then the answer to the overall question in step 38 is “Yes” (step 48). Then, in step 50, the system executes the pledge or initiates a process for rewarding the student according to the terms of the pledge. For example, the system may charge a preset reward amount to an account such as a bank account or a credit card account, or, send a bill to the sponsor. Further, the system may notify the sponsor and/or student. For example, when the pledge has been carried out, the system may send the sponsor an account statement describing transactions affecting the account balance and the underlying student performance information. The system may also send the student a congratulation message and the detail of the earned reward. In one embodiment, the system contacts the student on behalf of the sponsor with a follow-up message, e.g., when the sponsor wishes to remain anonymous.

FIG. 3 also can be used to illustrate how a system embodiment of the invention might function when it receives a new pledge from a sponsor (step 36). After the pledge is stored in a database (step 37), the system arrives at the central step 38 where the question is asked whether the new pledge condition is met by examining each piece of performance information stored in the system or otherwise available in the performance information database. In cases where the system associates the incoming pledge with the applicable student account(s), only performance information in those account(s) are examined. Then the query proceeds as outlined above from steps 40 to 50.

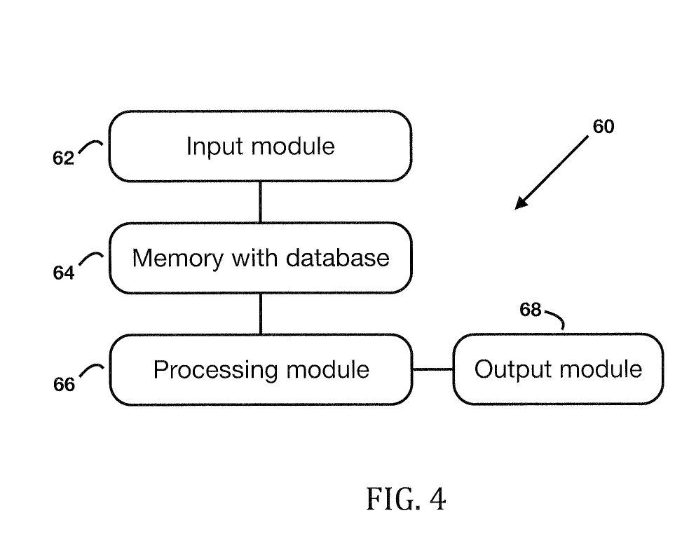

Referring now to FIG. 4, in an embodiment, the computer system 60 of the invention includes at least one input module 62, at least one memory 64 with a database, at least one processing module 66, and at least one output module 68. The input module 62 at least receives a student's performance information (see step 30 in FIG. 3). It or a separate input module can receive a sponsor's pledge (see step 36 in FIG. 3). The memory 64 is in communication with the input module 62 for storing part or all of the performance information. In one feature, the database in the memory 64 is searchable. In one embodiment, the memory 64 stores at least the “value” component of the performance information and/or the target “value” component of the pledge (see steps 32 and 37 in FIG. 3). The processing module 66, e.g., an Intel® processor, is in communication with the memory 64 and determines if the stored “value” component of the performance information meets the criterion, i.e., the target value, set in the pledge (see step 38 in FIG. 3). In one feature, the processing module 66, before further processing, dictates a validation process that validates the received performance information or at least its “value” component as described previously, e.g., but dictating an output module to send an inquiry to the institute issuing the performance information. The output module 68 is in communication with the processing module 66. In an embodiment, the output module 68 executes the sponsorship pledge by initiating a process for rewarding the student, e.g., by crediting the student's account with a pledged monetary amount, when the pledge condition is deemed by the processing module to have been met. In one feature, the processing module 68 sends out a printable report to a sponsor interested in sponsoring the student—in one embodiment, only when the sponsor's pledge condition is met and a transaction has been or will be carried out affecting the sponsor's pledged resources—in another embodiment, any time a performance report from the student is received. In one embodiment, the output module 68 sends out a follow-up message or correspondence to the student on behalf of the sponsor, e.g., when the sponsor wishes to remain anonymous.

Also, the system may solicit and receive personal information from the student user. In one feature, the system rewards a student user for providing personal information with money or its equivalent. In one embodiment, the system sets up a seed fund by paying small amounts of compensation each time an input module of the system receives individual performance and biological information filled out by the student user regardless if such information might satisfy an existing pledge or not. For example, submitting an SAT score can get a 25 cent deposit in a student's seed fund. Information that will earn money in such a seed fund includes not only the kind of performance information described previously, but also a wide variety of personal information that includes, e.g., date of birth, email address, current classes, resume, work experience, interest, and hobbies. With a large amount of information and over time, the seed fund can grow into a significant amount over the span of school years. And by the time the student is ready to be seek employment, a comprehensive profile of the student has been built that might assist a potential employer in the recruitment process. This kind of profile may also be useful for educational institutions interested in recruiting talented students, and to advertisers. In one embodiment, the personal information of a student user is stored in a searchable database, that may or may not be the same that stores performance information. The personal information should be subject to strict privacy and identity safeguard. And any solicitation of minor information ought to comply with all applicable laws and regulations including securing prior written guardian approval.

The system of the invention is preferably accessible through a network. The network can be an internetwork (e.g., the Internet/World Wide Web, an extranet, or an intranet), a global area network (GAN), a wide area network (WAN), a metropolitan area network (MAN), a Local area network (LAN), or a personal area network (PAN). The system includes convention components of a computer system including hardwares and softwares such as one or more processors, memories, displays, buses, network links, data-input devices (e.g., keyboard) and data-output devices (e.g., printers). In a particular embodiment, the system is linked to and accessible through the Internet/World Wide Web or an extranet.

In a further aspect, the system of the invention may function as a recruitment tool. In an embodiment, the invention provides a computer-based system that has an input module for receiving multiple pieces of performance information and/or personal information from a population of registered student users. The information is saved in a searchable format in a memory, e.g., in a searchable database. The information is preferably validated. In an embodiment, the status of validation is marked with each piece of data, i.e., the information has been validated or not. The system would allow a search, e.g., by a recruiter on behalf of a company or an educational institute, of the database using one or more criteria. For example, an automaker interested in recruiting engineers for its product development team might want to search for college and graduate students who have taken courses related to hydrogen fuel cells, especially those who did well in those course. For such a recruiter, the system would search its database with keywords such as “hydrogen fuel cell” and/or “automobile” in the “event” field and, optionally, any desired grade target in the “value” field, in order to generate a list of suitable candidates. Other criteria that can be searched may involve one or more of the following depending on the goal of the search: e.g., subject matter, topic, field, major, goal, industry, instructor, instructing institution, course, grade, academic score, athletic achievement, certification, credit score, admission or acceptance to an academic institution, and membership.

In one embodiment, the system contacts students on the list on behalf of the recruiter. Alternatively, the system provides a printable list to the recruiter. The identity of the students on the list may be protected by using account names they registered with the system, for instance, or, by using the system as a surrogate. The recruiter may choose to provide a reward to the students on the list as a goodwill gesture. Should the student become interested in responding to the recruiter, he can choose to reveal his identity at that point.

This provides a way for a recruiter to access a wide range of candidates. The recruiter can also tailor the searches according to a very specific need that conventional recruiting tools are not able to accommodate. Not only does the invention provides a highly specific and effective way to find an ideal candidate, it also is inexpensive, allowing companies and institutions that cannot afford expensive recruiting firms or the expenditure of on-campus recruitment, a valuable alternative.

While the present invention has been particularly shown and described with reference to the structures and methods disclosed herein and as illustrated in the drawings, it is not confined to the details set forth and this invention is intended to cover any modifications and changes as may come within the scope and spirit of the following claims.

We claim:

1. A computer-based system comprising:
an input module that receives a student's performance information comprising a value;
a memory in communication with said input module for storing at least said value;
a processing module in communication with said memory for determining if said value meets a criterion set in a sponsorship pledge by a sponsor; and
an output module in communication with said processing module for executing the sponsorship pledge by initiating a process for rewarding said student if said processing module determines that said value meets said criterion.

2. The system of claim 1 wherein said processing module validates said performance information before signaling said output module that said value meets said criterion.

3. The system of claim 2 wherein said system communicates said performance information to an institution for confirmation of its accuracy or authenticity.

4. The system of claim 1 wherein said performance information is transmitted from an institution that assigns said value.

5. The system of claim 1 wherein said performance information further comprises identity of the student and information on an event leading to an underlying performance.

6. The system of claim 1 wherein said rewarding said student comprises carrying out a transaction involving money or its equivalent.

7. The system of claim 6 wherein said money or its equivalent is selected from the group consisting of cash, credit, a fund, a gift, a grant, a scholarship, a loan, a good, a service, a discount, publicity, an experience, an offer for employment, and an interview for employment.

8. The system of claim 7 wherein said employment comprises an unpaid position.

9. The system of claim 1 wherein said input module further receives said sponsorship pledge in which said sponsor designates said criterion for student reward.

10. The system of claim 9 wherein said input module allows said sponsor to specify a cause to sponsor.

11. The system of claim 10 wherein said cause is selected from the group consisting of subject matter, topic, field, major, concentration, goal, industry, instructor, academic department, instructing institution, and course.

12. The system of claim 1 wherein said sponsor is selected from the group consisting of a person, a business, a government agency, a non-governmental organization, an educational institution, a foundation, and a trust.

13. The system of claim 1 wherein said sponsorship pledge rewards one or more students for getting a grade higher than a threshold value.

14. The system of claim 1, wherein said output module further transmits a printable report of at least said value in said performance information to said sponsor.

15. The system of claim 1, wherein said output module further transmits a printable report of the execution of said sponsorship pledge to said sponsor.

16. The system of claim 1 wherein said performance information comprises information selected from the group consisting of a grade, an academic score, an athletic achievement, a certification, an honor, an award, a credit score, admission or acceptance to an academic institution, and a membership.

17. The system of claim 1 accessible through the Internet.

18. The system of claim 1 wherein said output module further contacts said student on behalf of said sponsor.

19. The system of claim 1 wherein said memory stores said value in a searchable database.

20. The system of claim 1 wherein said input module further receives personal information from said student and said memory further stores said personal information.

21. The system of claim 19 wherein said output module pays said student each time personal information is received at said input module.

22. A method of rewarding a student for a performance, said method comprising the steps of:
providing a computer system to receive a student's performance information comprising a value;
storing at least said value in a database in said computer system;
determining if said value meets a criterion set in a sponsorship pledge by a sponsor; and
executing said sponsorship pledge by initiating a process for rewarding said student of said performance if said value is determined to meet said criterion.

23. The method of claim 22, wherein said computer system allows said sponsor to designate which student or students to sponsor.

24. The method of claim 22, wherein said computer system allows said sponsor to designate which cause to sponsor.

25. The method of claim 24 wherein said cause is selected from the group consisting of subject matter, topic, field, major, goal, industry, instructor, institution, and course.

26. The method of claim 22, further comprising the step of allowing a third party to search said memory.

27. The method of claim 26, further comprising the step of allowing said third party to offer a reward to one or more students identified through the search.

28. The method of claim 27, wherein said reward comprises an offer for employment or an interview for employment.

29. The method of claim 26, further comprising the step of contacting said student on behalf of said third party thereby keeping said student's identity hidden from said third party at least temporarily.

30. The method of claim 22, further comprising the steps of asking for personal information from said student, storing said personal information upon receipt, and paying said student each time personal information is received.

31. The method of claim 22 wherein said computer system is accessible through the Internet.

32. A computer-based system comprising:
an input module that receives multiple pieces of performance information from a plurality of students, each piece of information comprising a value;
a memory in communication with said input module for storing at least each of said values from said multiple pieces of performance information;
a search module in communication with said memory for searching values based on one or more criteria; and
an output module in communication with said search module for providing a printable search result of one or more students associated with one or more values that meet said one or more criteria.

33. The system of claim 32, wherein said printable search result excludes any information directly identifying said plurality of students.

34. The system of claim 32, wherein said one or more criteria comprises at least one entity selected from the group consisting of subject matter, topic, field, major, goal, industry, instructor, instructing institution, course, grade, academic score, athletic achievement, certification, credit score, admission or acceptance to an academic institution, and membership.

35. The system of claim 32, wherein said memory further stores personal information of said plurality of students.

36. The system of claim 32, wherein the system further attempts to validate each stored value.

37. The system of claim 32, wherein each performance information is indicated as to its validation status.

38. The system of claim 32, accessible through the Internet.
